(19) United States
(12) Patent Application Publication
(10) Pub. No.: US 2019/0045696 A1
(43) Pub. Date: Feb. 14, 2019

(54) Plant removal tool

(71) Applicant: Phil Schoeppner, Palmdale, CA (US)

(72) Inventor: Phil Schoeppner, Palmdale, CA (US)

(21) Appl. No.: 15/673,496

(22) Filed: Aug. 10, 2017

(51) Int. Cl. A01B 1/20; A01D 7/02; A01B 1/10

(52) U.S. Cl. CPC A01B 1/20; A01B 1/10; A01D 7/02

(57) ABSTRACT

A plant removal tool combining a rake and a hoe for removing plants from the ground includes a shaft that may be gripped. A hoe is coupled to the shaft and the hoe engages the ground when the shaft is manipulated. In this way the hoe chops plants growing in the ground. A rake is coupled to the shaft to rake the plants when the plants have been chopped.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed under 37 CFR 1.97 and 1.98.

The disclosure and prior art relates to removal devices and more particularly pertains to a new removal device combining a hoe and a rake for removing plants from the ground.

### BRIEF SUMMARY OF THE INVENTION

An embodiment of the disclosure meets the needs presented above by generally comprising a shaft that may be gripped. A hoe is coupled to the shaft and the hoe engages ground when the shaft is manipulated. In this way the hoe chops plants growing in the ground. A rake is coupled to the shaft to rake the plants when the plants have been chopped.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a plant removal tool according to an embodiment of the disclosure.

FIG. 2 is a top view of an embodiment of the disclosure.

FIG. 3 is a left side view of an embodiment of the disclosure.

FIG. 4 is a bottom view of an embodiment of the disclosure.

FIG. 5 is a front view of an embodiment of the disclosure.

FIG. 6 is a perspective in-use view of an embodiment of the disclosure.

### DETAILED DESCRIPTION OF THE INVENTION

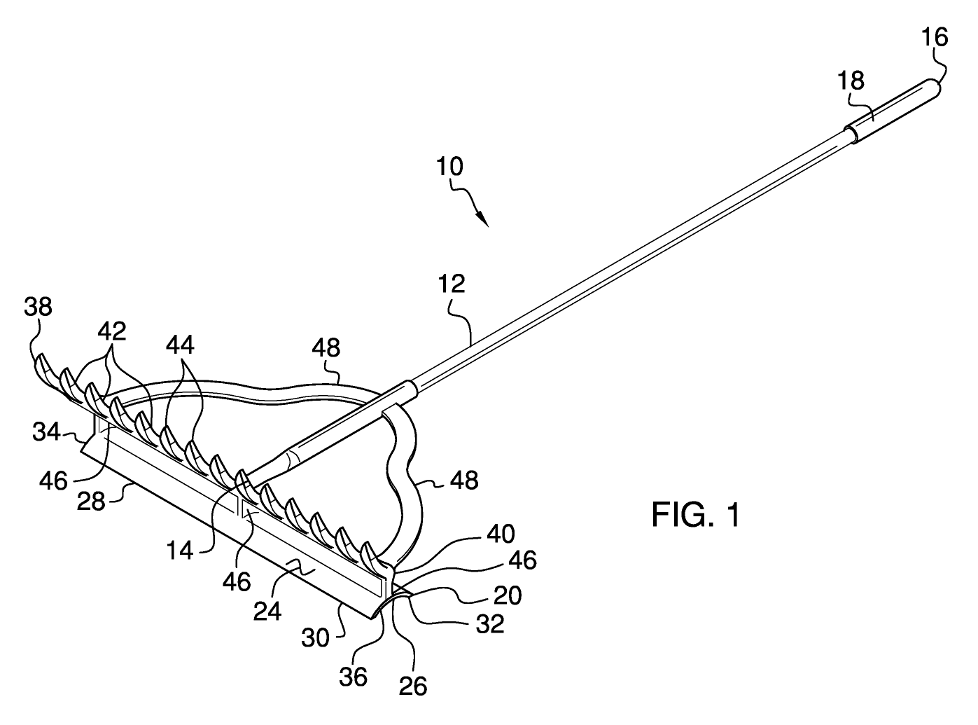

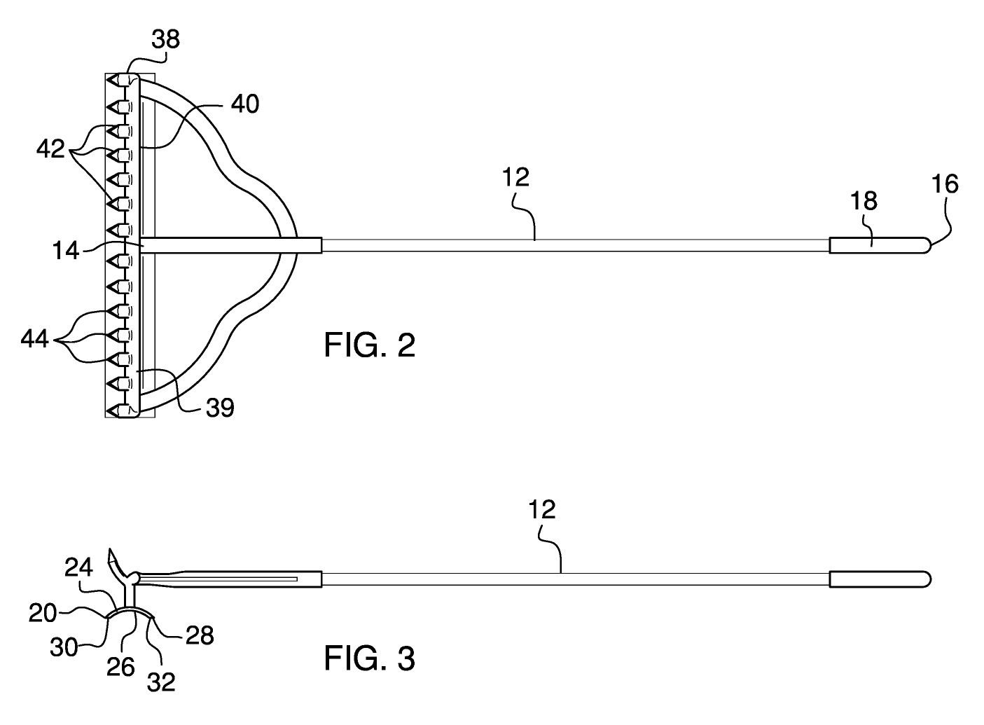

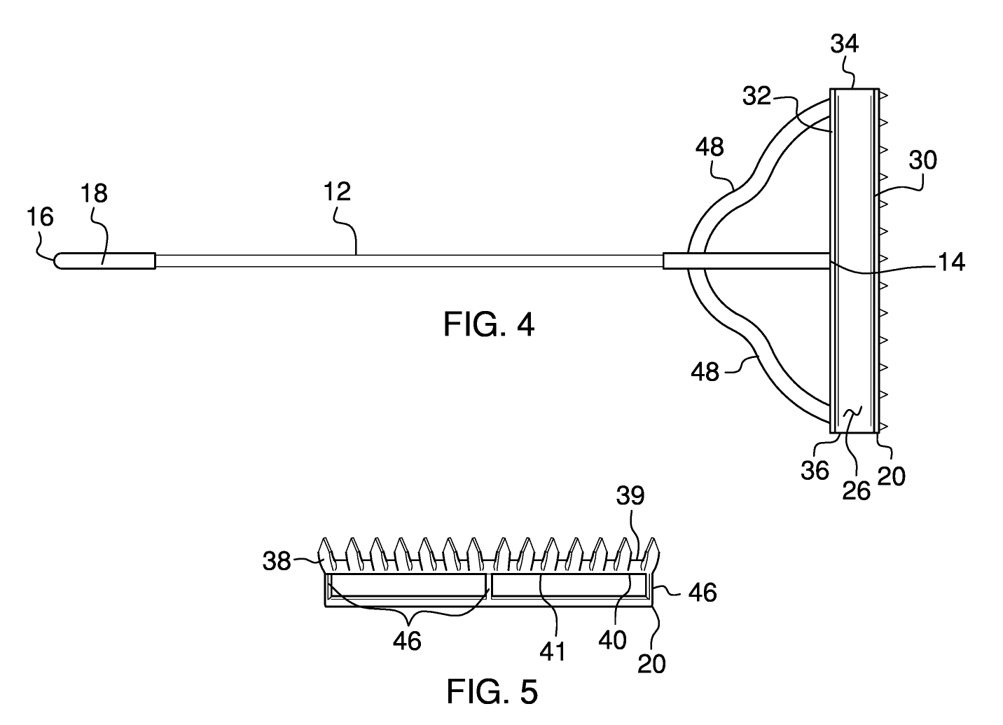

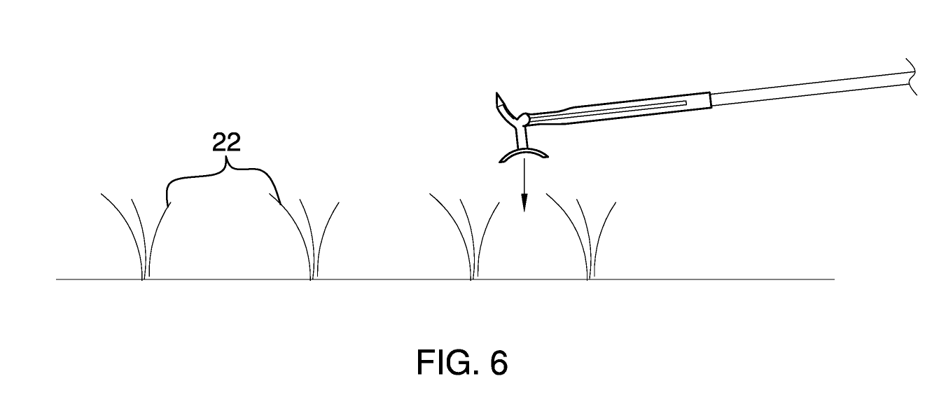

With reference now to the drawings, and in particular to FIGS. 1 through 6 thereof, a new removal device embodying the principles and concepts of an embodiment of the disclosure and generally designated by the reference numeral 10 will be described.

As best illustrated in FIGS. 1 through 6, the plant removal tool 10 generally comprises a shaft 12 that may be gripped. The shaft 12 has a first end 14 and a second end 16 and the shaft 12 may have a length ranging between approximately 120.0 cm and 150.0 cm. A grip 18 is coupled around the shaft 12 and the grip 18 is aligned with the first end 14. The grip 18 is comprised of a resiliently compressible material to enhance gripping the shaft 12. Additionally, the shaft 12 may be comprised of a metallic material such as steel or the like thereby inhibiting the shaft 12 from producing splinters.

A hoe 20 is provided and the hoe 20 is coupled to the shaft 12. The hoe 20 engages ground when the shaft 12 is manipulated thereby facilitating plants 22 growing in the ground to be chopped out of the ground. The plants 22 may be weeds in a garden or any other undesired plant. The hoe 20 has a first surface 24, a second surface 26 and a peripheral edge 28 extending therebetween. The peripheral edge 28 has a front side 30, a back side 32, a first lateral side 34 and a second lateral side 36. Each of the first 24 and second 26 surfaces is concavely arcuate between the front side 30 and the back side 32 such that the front side 30 is spaced from the back side 32. Moreover, each of the front side 30 and the back side 32 is sharpened to chop the plants 22 from the ground. The hoe 20 may have a length ranging between approximately 35.0 cm and 50.0 cm.

A rake 38 is provided and the rake 38 is coupled to the shaft 12 to rake 38 the plants 22 when the plants 22 have been chopped. The rake 38 comprises a member 40 that has a top side 39, and a bottom side 41. The first end 14 of the shaft 12 is coupled to the member 40 and the first end 14 is centrally positioned on the member 40. Moreover, the shaft 12 is oriented perpendicular to the member 40. The member 40 has a length that is equal to a length of the hoe 20. A ferrule may be coupled around the shaft 12 and the ferrule may engage the member 40.

A plurality of teeth 42 is provided and each of the teeth 42 is coupled to and extends upwardly from the top side of the member 40. The teeth 42 are spaced apart from each other and are distributed along the member 40. Each of the teeth 42 has a distal end 44 with respect to the member 40 and the distal end 44 corresponding to each of the teeth 42 tapers to a point. Each of the teeth 42 is arcuate between the member 40 and the distal end 44 such that each of the teeth 42 curves forwardly from the member 40.

A plurality of spacers 46 is provided and each of the spacers 46 is coupled between the first surface 24 of the hoe 20 and the bottom side of the rake 38 such that the rake 38 is spaced from the hoe 20. The spacers 46 are spaced apart from each other and are distributed along the member 40. Each of the spacers 46 may have a height ranging between approximately 5.0 cm and 7.0 cm. A pair of supports 48 is provided and each of the supports 48 is coupled between the shaft 12 and the member 40. Each of the supports 48 is positioned on opposite sides of the shaft 12 to inhibit the rake 38 and the hoe 20 from laterally deflecting on the shaft 12. Each of the supports 48 may undulate between the shaft 12 and the member 40.

In use, the shaft 12 is gripped and the shaft 12 is rotated to align the hoe 20 with the ground. The shaft 12 is manipulated to facilitate the hoe 20 to chop the plants 22 from the ground. The shaft 12 is rotated to align with rake 38 with the ground and the shaft 12 is manipulated to facilitate the teeth 42 on the rake 38 to engage the chopped plants 22. In this way the chopped plants 22 are raked from the ground for collection and disposal. The combination of the hoe 20 and the rake 38 enhances efficiency with respect to chopping and raking plants 22 compared to separate hoes and rakes.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A plant removal tool being configured to chop and rake plants, said assembly comprising:
a shaft being configured to be gripped;
a hoe being coupled to said shaft wherein said hoe is configured to engage ground when said shaft is manipulated thereby facilitating plants growing in the ground to be chopped out of the ground; and
a rake being coupled to said shaft wherein said rake is configured to rake the plants when the plants have been chopped.

2. The assembly according to claim 1, wherein said hoe has a first surface, a second surface and a peripheral edge extending therebetween, said peripheral edge having a front side, a back side, a first lateral side and a second lateral side, each of said first and second surfaces being concavely arcuate between said front side and said back side such that said front side is spaced from said back side.

3. The assembly according to claim 2, wherein each of said front side and said back side is sharpened wherein each of said front side and said back side is configured to chop the plants from the ground.

4. The assembly according to claim 1, wherein:
said shaft has a first end; and
said rake comprises a member having a top side, and a bottom side, said first end of said shaft being coupled to said member, said first end being centrally positioned on said member, said shaft being oriented perpendicular to said member.

5. The assembly according to claim 4, further comprising a plurality of teeth, each of said teeth being coupled to and extending upwardly from said top side, said teeth being spaced apart from each other and being distributed along said member, each of said teeth having a distal end with respect to said member, said distal end corresponding to each of said teeth tapering to a point, each of said teeth being arcuate between said member and said distal end such that each of said teeth curves forwardly from said member.

6. The assembly according to claim 5, further comprising:
said hoe having a first surface; and
a plurality of spacers, each of said spacers being coupled between said first surface of said hoe and said bottom side of said rake such that said rake is spaced from said hoe, said spacers being spaced apart from each other and being distributed along said member.

7. The assembly according to claim 4, further comprising a pair of supports, each of said supports being coupled between said shaft and said member, each of said supports being positioned on opposite sides of said shaft such that each of said supports inhibits said rake and said hoe from laterally deflecting on said shaft.

8. A plant removal tool being configured to chop and rake plants, said assembly comprising:
a shaft being configured to be gripped, said shaft having a first end and a second end;
a hoe being coupled to said shaft wherein said hoe is configured to engage ground when said shaft is manipulated thereby facilitating plants growing in the ground to be chopped out of the ground, said hoe having a first surface, a second surface and a peripheral edge extending therebetween, said peripheral edge having a front side, a back side, a first lateral side and a second lateral side, each of said first and second surfaces being concavely arcuate between said front side and said back side such that said front side is spaced from said back side, each of said front side and said back side being sharpened wherein each of said front side and said back side is configured to chop the plants from the ground;
a rake being coupled to said shaft wherein said rake is configured to rake the plants when the plants have been chopped, said rake comprising:
a member having a top side, and a bottom side, said first end of said shaft being coupled to said member, said first end being centrally positioned on said member, said shaft being oriented perpendicular to said member, and
a plurality of teeth, each of said teeth being coupled to and extending upwardly from said top side, said teeth being spaced apart from each other and being distributed along said member, each of said teeth having a distal end with respect to said member, said distal end corresponding to each of said teeth tapering to a point, each of said teeth being arcuate between said member and said distal end such that each of said teeth curves forwardly from said member;
a plurality of spacers, each of said spacers being coupled between said first surface of said hoe and said bottom side of said rake such that said rake is spaced from said hoe, said spacers being spaced apart from each other and being distributed along said member; and
a pair of supports, each of said supports being coupled between said shaft and said member, each of said supports being positioned on opposite sides of said shaft such that each of said supports inhibits said rake and said hoe from laterally deflecting on said shaft.
